(19) United States
(12) Patent Application Publication
(10) Pub. No.: US 2014/0095988 A1
(43) Pub. Date: Apr. 3, 2014

(54) CREATING AND CONSUMING STREAMING E-BOOK CONTENT

(71) Applicant: Bookboard, Inc., Burlingame, CA (US)

(72) Inventors: Nigel Pegg, San Francisco, CA (US); Fang-Kuey Chang, Mountain View, CA (US)

(21) Appl. No.: 13/631,980

(22) Filed: Sep. 29, 2012

(51) Int. Cl. G06F 17/21

(52) U.S. Cl. CPC G06F 17/217
USPC 715/251

(57) ABSTRACT

A collection of resources comprising an electronic book is analyzed and a list describing the electronic book is created, wherein the list identifies the resources used in rendering pages of the electronic book. A maximum payload for each page is determined and the electronic book is modified by moving resources used in rendering various pages to other pages, such that the payload of each page does not exceed the maximum payload designated for the page.

### BACKGROUND

Electronic books (“e-books”) may comprise a number of formats, with the most popular being the “electronic publishing” format (“EPUB”), an e-book format standard from the International Digital Publishing Forum (IDPF). E-books are often packaged in a single file containing a large number of assets, such as text, graphics, audio and video, and these assets are usually jumbled together and not organized in a coherent manner. Prior to reading an e-book, this complex file must be downloaded to a device in its entirety, which can take a significant amount of time, depending on the size of the files comprising the e-book.

### SUMMARY

This specification describes technologies relating generally to adapting electronic books.

In general, one aspect of the subject matter described in this specification can be embodied in a method that includes analyzing a collection of resources comprising an electronic book, wherein the electronic book comprises a first and second page of a plurality of pages. Based on the analysis, a list is created that describes the electronic book, wherein the list identifies the resources used in rendering the first and second page. Then, the file size of each resource used in rendering the first page is calculated and a maximum payload for the first page is determined. Based on the determination, the first page may be modified by moving resources used in rendering the first page to the second page, such that the payload of the first page does not exceed the maximum payload for the first page.

Another aspect of the subject matter described in this specification can be embodied in one or more computer-readable storage mediums storing one or more sequences of instructions for adapting e-books, which when executed by one or more processors performs steps including analyzing a collection of resources comprising an electronic book, wherein the electronic book comprises a first and second page of a plurality of pages. Based on the analysis, a list is created that describes the electronic book, wherein the list identifies the resources used in rendering the first and second page. Then, the file size of each resource used in rendering the first page is calculated and a maximum payload for the first page is determined. Based on the determination, the first page may be modified by moving resources used in rendering the first page to the second page, such that the payload of the first page does not exceed the maximum payload for the first page.

Another aspect of the subject matter described in this specification can be embodied in a method that includes analyzing a collection of resources comprising an electronic book, wherein the electronic book comprises a plurality of pages, and then creating an electronic manifest, wherein the electronic manifest associates each of the plurality of pages with the particular resources comprising each of the plurality of pages. Data defining a maximum payload for each page of the plurality of pages is stored in the manifest, and the manifest is downloaded to an electronic book reader device. Based on the manifest, a virtual layout of the plurality of pages is generated at the electronic book reader device, wherein the layout specifies which resources are to appear on which page based on the maximum payload defined for each page. A first page of the plurality of pages is displayed on the electronic book reader device, wherein the step of displaying the first page comprises downloading the resources associated with the first page, and resources associated with a second page and a third page of the plurality of pages are downloaded to the electronic book reader device, wherein the second page and a third page are adjacent to the first page.

The details of one or more implementations are set forth in the accompanying drawings and the description below. Other features will be apparent from the description and drawings, and from the claims.

### BRIEF DESCRIPTION OF THE DRAWINGS

Some embodiments are illustrated by way of example and not limitation in the figures of the accompanying drawings, and in which like reference numerals refer to similar elements, and in which:

FIG. 1 is an illustration 100 depicting an example embodiment of adaptive initial payload and rendering techniques, according to an embodiment;

FIG. 2 is a flow chart showing an example process 200 for processing an e-book into a stream-enabled adaptive initial payload format, according to an embodiment;

FIG. 3 is a flow chart showing an example process 300 for enabling the consumption of stream-enabled e-book content, according to an embodiment;

FIG. 4A is an illustration 400 depicting an example embodiment of text block hit areas, according to an embodiment;

FIG. 4B is an illustration 400 depicting an example embodiment of text block hit areas, according to an embodiment;

FIG. 4C is an illustration 400 depicting an example embodiment of text block hit areas, according to an embodiment; and

FIG. 5 is a block diagram that illustrates an example computer system upon which example embodiments may be implemented.

### DETAILED DESCRIPTION

Approaches for adapting e-books for more efficient transmission, storage and consumption are presented herein. In the following description, for the purposes of explanation, numerous specific details are set forth in order to provide a thorough understanding of the embodiments described herein. It will be apparent, however, that the embodiments described herein may be practiced without these specific details. In other instances, well-known structures and devices are shown in block diagram form or discussed at a high level in order to avoid unnecessarily obscuring teachings of embodiments.

### Functional Overview

While current approaches to reading e-books is to download the entire collection of resources used to render the e-book prior to allowing a user to begin reading the e-book, approaches are described for streaming e-books over a network by adapting the payload of e-books and progressively storing them locally.

In an example embodiment, an e-book file, such as an EPUB, is analyzed and a stream-enabled manifest is created that identifies each page of the e-book along with the resources necessary to render the pages. Using this manifest, each page and its attendant resources are analyzed to determine the amount of data required to be downloaded before a particular page can be rendered on the local device (“payload”). Based on the analysis, the resources associated with the first section of pages of the e-book are adapted such that the payload of resources for the first few pages is reduced, thereby allowing the beginning pages to be downloaded faster and the user to begin reading immediately.

In an example embodiment, once the manifest is created, it is downloaded to the local device and used to download resources on-demand based on whichever page the user desires to read. While the user is reading a page, the resources for adjacent pages are downloaded. All downloaded resources are tracked, such that if a user switches to another page prior to all resources for the current page being downloaded, the downloaded resources are not re-downloaded once the user switches back to the initial page.

### Stream-Enabled Adaptive Initial Payload for Ebook Content

Some current versions of EPUBs comprise a “black box” of resources. EPUBs are a compressed, archived file of all resources used in an e-book. While the present disclosure discusses techniques for processing e-books using the example of an EPUB, it should be understood that the techniques discussed herein are not limited solely to EPUBs or any single e-book or document file format.

These resources may comprise various types of files, such as: text, HTML, graphics, video, sound, interactive elements, and so on. Some sort of table of contents file (TOC) usually is part of this jumbled package of files, which TOC allows for the files to be verified and ordered for display via an e-book reader. As discussed herein, because the TOC is delivered as part of the compressed, archived EPUB file, the entire EPUB must be downloaded prior to extracting the TOC and utilizing it to to ensure all embedded content is available and to determine the order of major pages in the book.

E-book readers generally serve as an interpreter for the files comprising the e-book. For example, an e-book reader may comprise an HTML interpreter for parsing the HTML files, one or more image processing tools for handling the graphic files (e.g., JPEGs, PNGs, SVG, etc.), an audio program for playing the audio files, and so on. Once an e-book is downloaded in its entirety, the e-book reader works its way through the flat file structure depending on the page being rendered at any given time.

For example, a user may download an e-book, which as discussed above, is comprised of a compressed archive of various files that in their entirety make up the e-book. The user is unable to begin reading the e-book as it is downloading because the e-book reader is unable to derive the order and interrelations between the delineated pages and the various resources linked to each page until the entire package is downloaded. Once the e-book has been downloaded, the table of contents file (TOC) is located and analyzed to ensure all embedded content is available, and to determine the order of major pages in the book. Essentially, the TOC is only useful for checksums (determining if all contents are present), and the ordering of content pages (not the resources within them). Because the list of resources comprising the e-book is not hierarchical, a sample list of files may resemble the following:
dog.png
page50
page1.html
rainbow.svg
trumpet.wav
page13.html

A standard e-book/ePub reader does not look up resources in the TOC; rather, it assumes that at the time of rendering, all resources will be available at locations referred to from the page content itself (e.g., HTML pages). Essentially, the rendering engine accesses resources on-the-fly, rather than allowing for prefetching. In an example, if a user navigates to page 1, the e-book reader accesses “page1.html” and only at that point determines that “dog.png” and “trumpet.wav” are needed to render page 1. The e-book reader scans through the list of packaged resources, locates the needed files, and then assembles them to render page 1. While the TOC might have all the files listed above here, only “page50.html” or “page1.html” will have any notion that they may contain rainbow.svg or trumpet.way. The association between pages and resources is internal to the pages themselves.

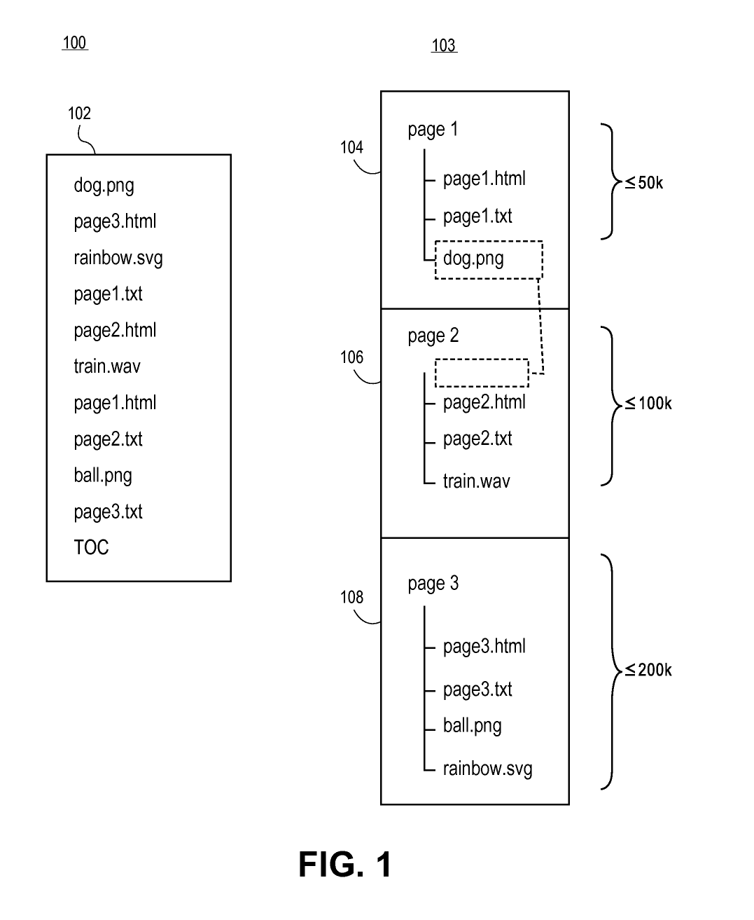

FIG. 1 is an illustration 100 depicting an example embodiment of adaptive initial payload and rendering techniques. As discussed earlier, example e-book formats (e.g., EPUB) comprise a compressed, archived collection of resources 102 used in the rendering of an e-book. In the example of FIG. 1, collection of resources 102 comprises various files (e.g., page1.html, page2.html, page3.html) that comprise a three-page e-book. The list of FIG. 1 is not exhaustive, as any number and type of files may be utilized in an e-book.

According to an example embodiment, collection of resources 102 are analyzed and a separate stream-enabled manifest 103 is created that hierarchically orders collection of resources 102 according to their location in the e-book. In example embodiments, the analyzing, processing and creating may be performed by the same component (e.g., code comprising a “processing engine” or module, for example), while other embodiments envision separate components performing separate aspects of the techniques described herein. In an embodiment, the components performing the process(es) may reside on a server, a client, or both. In one example, manifest 103 comprises one or more symbolic tables, which may comprise a hierarchically-arranged tree of object symbols, such as XML, JSON, or any binary format which can indicate parent-child relationships between objects contained therein. This manifest 103 may be in a format that allows it to be accessible via a network, for example being streamed or downloaded from a server. In an embodiment, manifest 103 contains information identifying the major sections of the e-book, such as pages, chapters, resources and other parts.

Manifest 103 represents the actual hierarchy of pages 104-108 making up the e-book, as well as the resources required to render each page. According to an embodiment, once manifest 103 is created, the size of the files comprising each page 104-108 is analyzed, and various assets may be resampled or otherwise compressed to reduce file size, or shifted from one page to another in order to reduce the amount of data that must be downloaded for the first few pages of the e-book (or, in alternate embodiments, any particular page or section of pages, not just the first pages). Rather than download the entire e-book before allowing a user to begin reading, it is advantageous to structure the downloading of assets comprising the e-book so that the first pages of the e-book may be downloaded more quickly. By adapting the initial payload of an e-book (e.g., early pages) to require less downloading time than subsequent payloads (e.g., later pages), a user may begin reading the e-book almost instantaneously.

In the example of FIG. 1, page one 104 may be modified to require a download of less than 50 k payload of data; for example, by shifting a large file originally intended to be rendered on page one 104 (such as “dog.png”) to page two 106 or other subsequent page. As discussed later, this is the “bandwidth curve” for a particular page. In an embodiment, certain assets may be prioritized for downloading, such as text that is supposed to be rendered on a certain page (e.g., “page1.txt”). In an example, a placeholder such as a shaded box or other visual cue may be rendered in place of the shifted resource. The bandwidth curves of FIG. 1 may be predetermined, for example by manifest 103, or may be dynamically calculated based on factors such as bandwidth, network transmission speed, device specifications, and so on. In another example, bandwidth curves may be determined by the processing engine, as described herein.

Continuing the example of FIG. 1, page two 106 may be modified to require a download of less than 100 k of data, and page three 108 may be modified to require a download of less than 200 k of data. As discussed earlier, these data payload limits are adaptive.

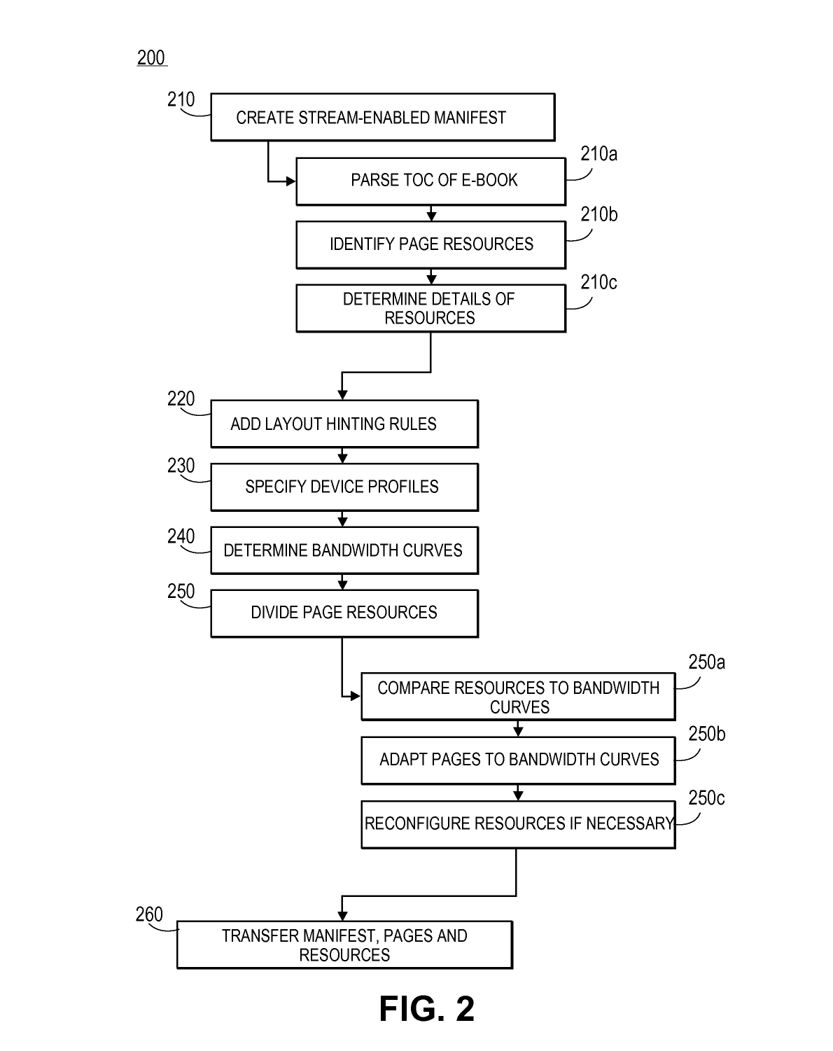

FIG. 2 is a flow chart showing an example process 200 for processing an e-book into a stream-enabled adaptive initial payload format according to an embodiment. At 210, the contents of the ePub (or other e-book format) are analyzed and the stream-enabled manifest is created. According to an embodiment, the stream-enabled manifest comprises a hierarchical data structure (usually in memory, but can be output to storage as well) detailing specifics about the e-book contents and the relationships between the contents, specifically between pages and the resources they contain. The structure of the e-book is traversed and all internal associations are externalized to enable streaming capability, as discussed herein.

In an example, step 210 is comprised of three sub-steps. At 210a, the TOC of the e-book is parsed and each page is added as a parent object in the stream-enabled manifest, in the order in which they are to appear.

At 210b, for each page listed, the corresponding page file (e.g., a text file, HTML file, XML file or the like) is accessed and parsed to identify all resources referred to in that page. A resource entry for that resource is created in the stream-enabled manifest, for example as a child object of the appropriate page parent object referenced in 210a.

At 210c, for each resource identified in 210b, the corresponding file is accessed and its dimensions and file size are determined. These details are added to the resource entry created in 210b.

At 220, the set of page resources as stored in the stream-enabled manifest detailed in 210a-210c are iterated through, and layout hinting rules appropriate for the resources in each page are added. In an embodiment, layout hinting specifies whether a given resource needs to appear alone on a page, or must appear together with other resources on a page, as well as specifying their relative positioning, in order to make a readable page. This may be provided via a user interface or other means. The contents of pages of a typical e-book are relatively fluid; that is, what is described as a “page” in an e-book (or PDF, or other similar format) might not fit on a given device screen without significantly reducing the “page” size, rendering the page unreadable. However, if the contents of that page were split or divided into multiple pages, they could be more easily displayed on a given device profile, both in terms of dimensions (readability) and file size that needs to be downloaded at a time.

At 230, device profiles for a given e-book consumption device are specified; e.g., an iPad, Kindle, laptop or other device. In an embodiment, the device profiles contain information relating to the e-book reading environment, such as the expected network transfer rate, display dimensions, aspect ratio, display resolution, etc. In other embodiments, a simple configuration of processing directives for other devices can be utilized to determine alternate device profiles.

At 240, a bandwidth curve for the complete set of pages is determined. A bandwidth curve in one example specifies maximum file sizes for given pages (as discussed with reference to FIG. 1), according to their position within the book and the device profile specified in 230. In an embodiment, pages towards the beginning of the book should be optimized in order to reduce initial loading time as much as possible for the rendering engine.

At 250, the stream-enabled manifest from 210a-210c is iterated through, for example by the same or a different module that analyzed the resources and created the manifest, using the device profile specified in 230, in order to divide the original page resources into sizes that more easily fit the layout dimensions and bandwidth profile of the device as well as the bandwidth curve of the page within the book (per 240), while respecting the layout hinting rules of the content itself (per 220). The stream-enabled manifest is updated to reflect this analysis. In an example embodiment, this iteration is a second “pass” through the outputs of the earlier passes that created the manifest.

In an example, step 250 is comprised of three sub-steps. At 250a, for each page, it is determined whether its combined set of resources (text, images, etc.) will be larger than the device profile allows (per 230), or more costly in bandwidth than the bandwidth curve allows (per 240). If they are, then the layout hinting rules are analyzed as determined in 220. If layout rules are not broken in so doing, excess resources are pushed to the next page. If the current page is the last page, and more resources need to be pushed beyond its boundary, new pages may be created.

At 250b, for each page, if the process described in 250a results in pages that are too costly in total file size, page resources may be resampled or otherwise compressed (e.g., in a lossy way) in order to bring them within the limits prescribed by the bandwidth curve as in 240.

At 250c, for each individual page resource, if its dimensions are greater than the device profile's maximum allowed screen width or height, the resource is reconfigured to fit within these maximum values (e.g., resized).

At 260, the stream-enabled manifest and all pages and resources may be transferred to a network location (e.g., server) to be accessed remotely by a rendering engine (e.g., e-book reader or application). In example embodiments, the processing engine may output different sets of content for different device profiles.

The process 200 can be implemented by a component executing on a server, a client or both, or by a different device or system. In some implementations, the process 200 can include fewer, additional and/or different operations. In other examples, only one or some subset of these operations may be included, as each operation may stand alone, or may be provided in some different order other than that shown in FIG. 2. For clarity, a e-book reading device will be referred to with regard to the description of FIG. 2, but it should be understood that the example embodiments described herein are not so limited. For example, the techniques described herein could be adapted to a web-based e-book consumption approach.

### Consuming Stream-Enabled E-Book Content

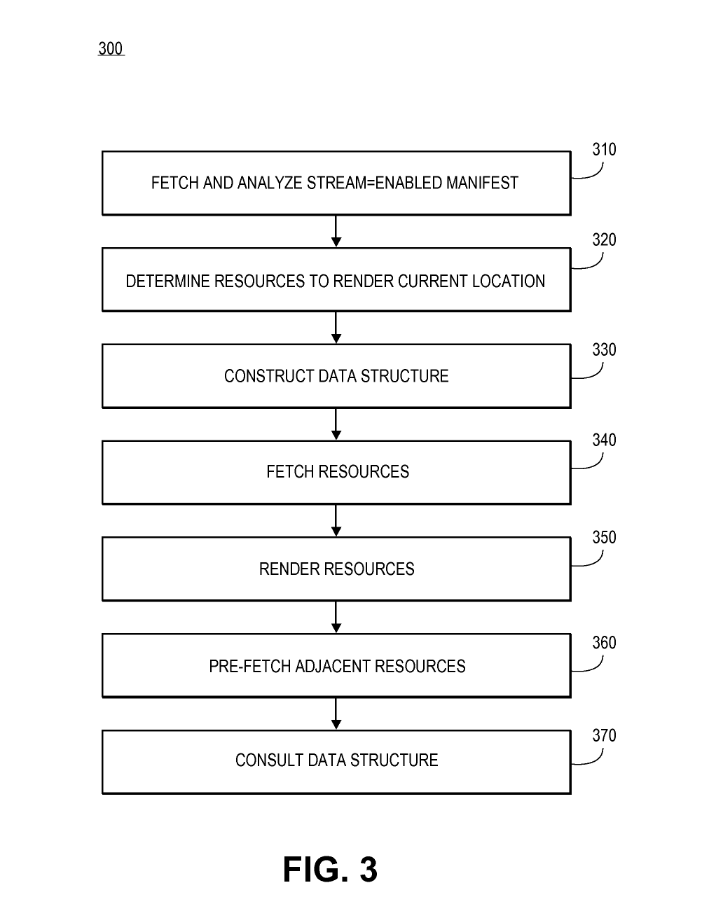

FIG. 3 is a flow chart showing an example process 300 for enabling the consumption of stream-enabled e-book content according to an embodiment. At 310, the stream-enabled manifest is fetched from its network location in order to parse and analyze its contents. In an example embodiment, this step is initiated by code comprising a type of module, such as a “rendering engine,” which may be executing on a device such as an e-book reader. Depending on the orientation of the device and the dimensions (or other properties) of the resources to display, the contents may be displayed in a one-page or two-page layout. Information in the manifest may be used to build a virtual page layout table, respecting layout hinting rules encoded within the manifest (for example, certain two-page layouts may be preferred over others, depending on the rules entered).

At 320, using the virtual page layouts built in 310, and based on the location desired within the book, the pages and resources required to render the current location within the book are determined.

At 330, a data structure is constructed which will record whether or not a given resource has been downloaded and stored locally by the rendering engine. For example, a hash table may be used with the URL of the resource as key and “true” or “false” as the value, indicating its local status. This data structure can also be stored locally for subsequent access. This data may additionally be incorporated into the stream-enabled manifest, according to an embodiment.

At 340, using the list of pages and resources required to render the current location as determined in 320, resources are fetched from the locations indicated in the stream-enabled manifest file. Once they have finished fetching, they are stored locally and their status is updated in the data structure of 330, to indicate that they are now locally stored.

At 350, once all resources required to render the current location are fetched, render them on-screen as dictated by their virtual page layout determined in 320.

At 360, resources for the page layouts directly adjacent to the current page are fetched prior to rendering (“pre-fetched”), both ahead and behind. As the resources are loaded, their presence is noted in the data structure created in 330. As subsequent page resources finish loading, continue pre-fetching assets for subsequent adjacent pages, until all pages are fetched.

At 370, as a user moves from location to location within the book, consult data structure of 330 before attempting to fetch any given resource. If that resource isn't stored locally, fetch it from its original location (e.g., on a server). If it is stored locally, the fetching can be skipped.

The process 300 can be implemented by a component executing on a server, a client or both, or by a different device or system. In some implementations, the process 300 can include fewer, additional and/or different operations. In other examples, only one or some subset of these operations may be included, as each operation may stand alone, or may be provided in some different order other than that shown in FIG. 3. For clarity, a e-book reading device will be referred to with regard to the description of FIG. 3, but it should be understood that the example embodiments described herein are not so limited. For example, the techniques described herein could be adapted to a web-based e-book consumption approach.

As a user selects the e-book for reading at a local client, the client (e.g., an e-book reader) accesses manifest 103 and determines which particular resources are required to render whichever page 104-108 the user requests. In an embodiment, the client downloads manifest 103 to the local client

### Progressive Downloading and Storing

In the example embodiments described herein, a user, via a network, browses a list of e-books available for reading over the network. As an example, the user selects the e-book represented in FIG. 1, which is comprised of collection of resources 102. Instead of downloading the entire e-book, which requires waiting for the compressed archive of files comprising the e-book to be downloaded to the local device from the network, and then each page being assembled on-demand according to the individual page contents by sequentially scanning the flat list of files comprising the e-book (as described earlier), stream-enabled manifest 103 is created and downloaded, although in alternate embodiments stream-enabled manifest 103 is server-based.

Depending on which page the user wishes to read, the e-book streaming engine (which could be a component or module used within an e-book reader application of embedded directly into an e-book reading device, for example) determines, based on stream-enabled manifest 103, that certain resources should be downloaded. In the example of FIG. 1, if the user chooses to read page three, the rendering engine consults stream-enabled manifest 103 and determines that “page3.css”, “page3.txt”, “ball.png” and “rainbow.svg” must be downloaded in order to render the page.

According to an embodiment, because it is more efficient to store resources locally (e.g., on a disk or flash storage) for e-book rendering, any time that is not spent switching between pages is used to download collection of resources 102 as identified by stream-enabled manifest 103. In one example, the resources will be downloaded for the pages adjacent to the currently-selected page and then spread out in each direction therefrom. This allows a user to be reading page 16 while pages 15 and 17 or downloaded in the background. Most of the time, the user will switch to a contiguous page for further reading, so this approach offers more efficient use of bandwidth. Rather than download page 16 and then start downloading from page 1, the pages most likely to be viewed next will be downloaded to the local device.

In an example, a first downloading pass is made to download stream-enabled manifest 103 store it locally in memory as a hierarchical data structure. This data structure is further annotated by the e-book streaming engine upon downloading of any resource to indicate that the resource is now available locally, as described with reference to FIG. 2. In a second downloading pass, collection of resources 102 will be downloaded according to the page that the reader is currently viewing (including resources for surrounding pages, as described above). A record of which resources have been downloaded is maintained, for example by modifying stream-enabled manifest 103 or maintaining a separate file or data structure (e.g., a database or text file). In this example, if a user flips to page three 108, the e-book streaming engine begins to download the resources identified in manifest 103. If only “ball.png” is downloaded before the user flips to another page, the local presence of “ball.png” is recorded so that if the user flips back to page three, “ball.png” is not re-downloaded.

### Text Block Hit Area

According to an embodiment, after initial creation of the stream-enabled manifest (as described above with reference to FIG. 2), each resource in the stream-enabled manifest is analyzed, for example by an automated process or manually (e.g., through an application UI). Blocks of text are identified within a particular resource and the (x,y) coordinates as well as the dimensions of the text blocks are determined. The coordinates and dimensions of these text blocks are added to the entry for the resource in question in the stream-enabled manifest, such that the resource and the text block information are associated.

According to an embodiment, upon creation of the virtual page layout table for the rendering engine (as described above with reference to FIG. 3), when a resource is to be displayed, its associated text block regions are analyzed, and the original coordinates and dimensions of these regions (as previously determined and associated with the resource) are adjusted for the coordinates and dimensions of the resource within the current (rendered) layout.

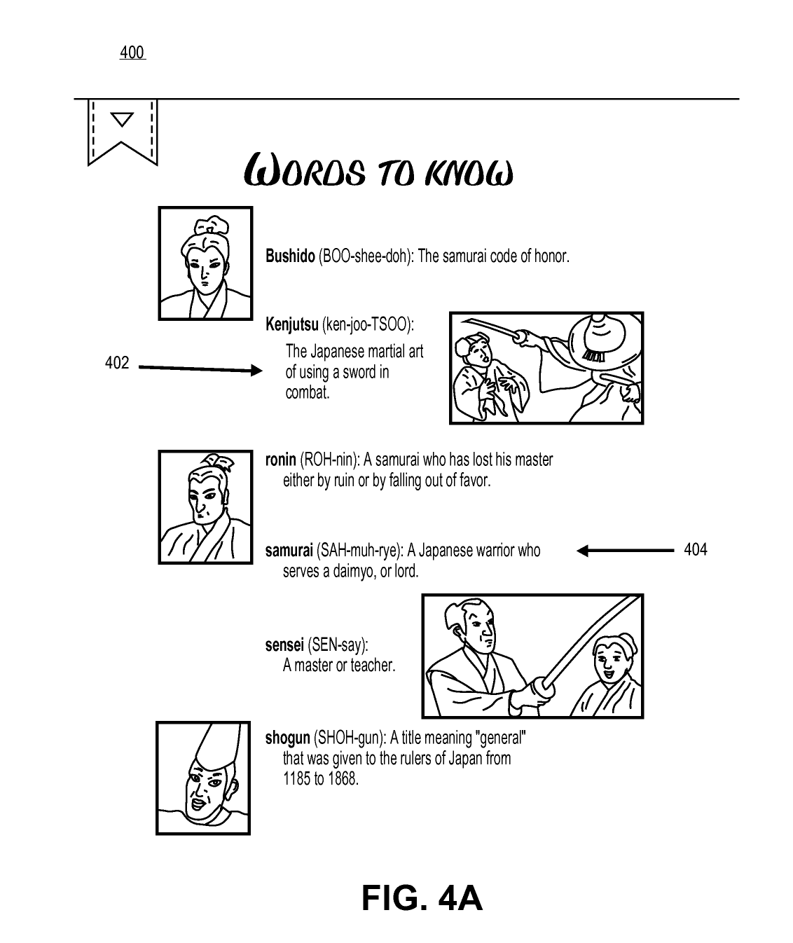

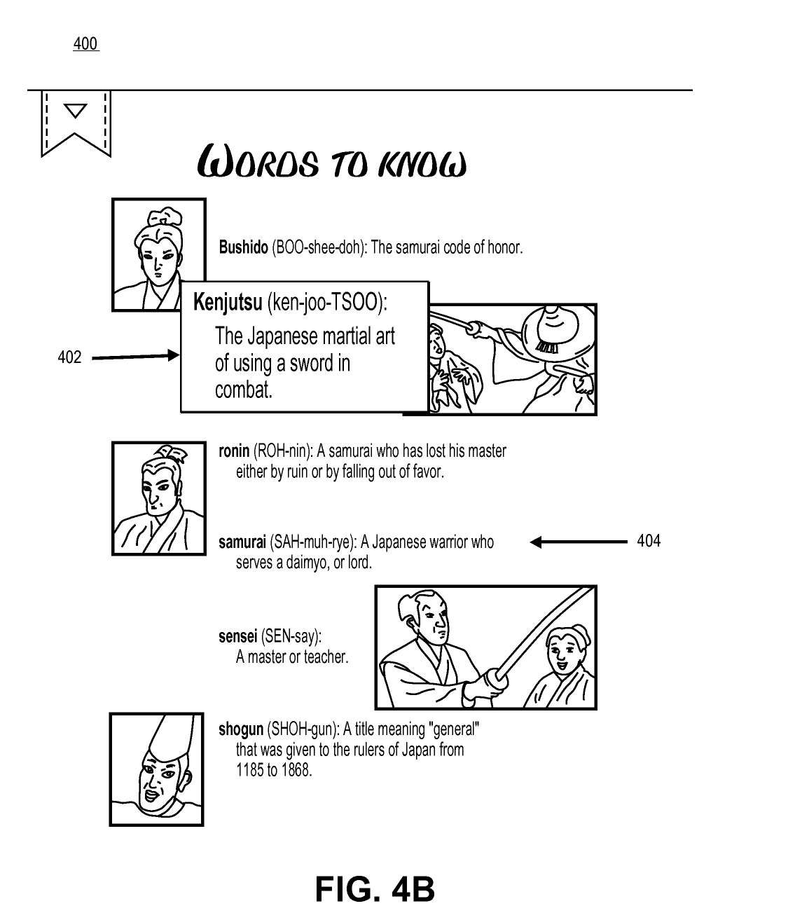

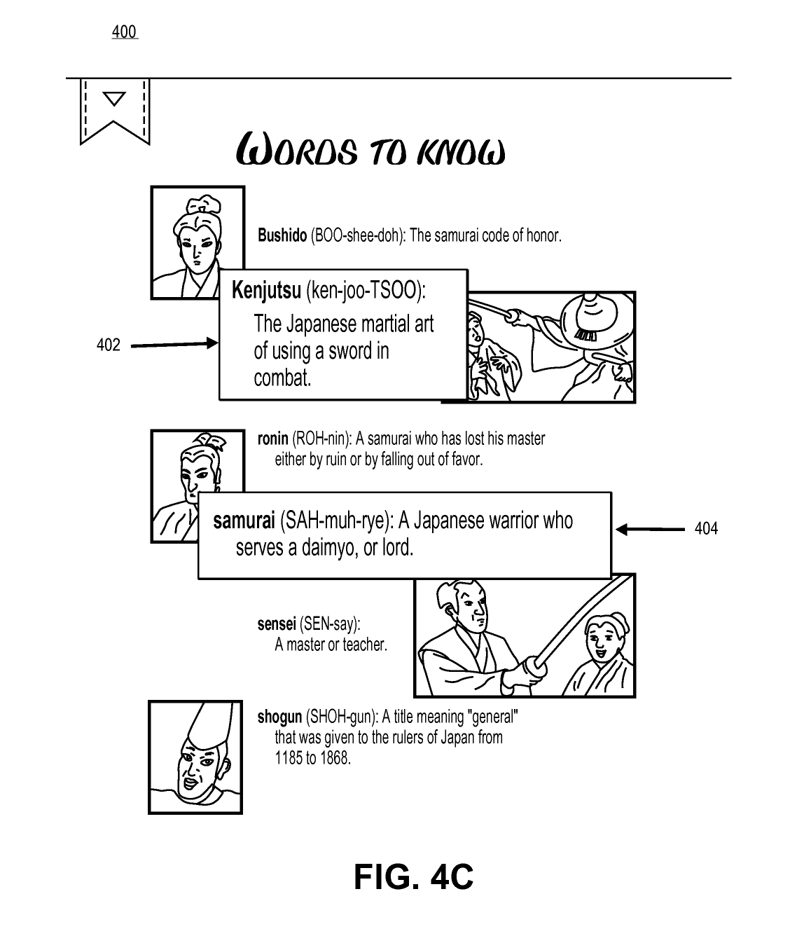

FIGS. 4A-4C are illustrations 400 depicting an example embodiment of text block hit areas, according to an embodiment. In FIG. 4A, example text block regions 402, 404 are rendered according to the techniques described herein. When a user taps, clicks, or otherwise activates a region on the screen, the rendering engine determines whether that gesture takes place within a region associated with a text block resource (“hit area”). If so, the rendering engine displays the text region 402, 404 at its original dimensions, for example at a location centered around the associated “hit area” region, as depicted in FIGS. 4B and 4C. In alternate embodiments, the text region 402, 404 may be displayed as a percentage of its original dimensions, determined at rendering time or predetermined, for example with a preference setting. The positioning of the “enlarged” text region 402, 404 displayed as a result of user activation may similarly be adjusted in alternate embodiments.

### Alternate Implementations

To implement some or all of the various technologies described above, components described in the present specification may provide one or more application programming interfaces (APIs) or other interfacing logic or circuitry to allow the described components to communicate with the various systems described herein to facilitate those technologies.

While specific methods, tasks, operations, and data described herein are associated above with specific systems, other embodiments in which alternative apportionment of such tasks and data among the various systems are also possible. Further, while various systems, may be shown as separate entities in the Figures, one or more of these systems may be combined into one or more larger computing systems in other embodiments.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

Example embodiments may be implemented in digital electronic circuitry, or in computer hardware, firmware, or software, or in combinations thereof. Example embodiments may be implemented using a computer program product (e.g., a computer program tangibly embodied in an information carrier in a machine-readable medium) for execution by, or to control the operation of, data processing apparatus (e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communications network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a field programmable gate array (FPGA) or an application-specific integrated circuit (ASIC)).

The computing system can include clients and servers. While a client may comprise a server and vice versa, a client and server are generally remote from each other and typically interact through a communication network. The relationship of client and server arises by virtue of computer programs running on their respective computers and having a client-server relationship to each other. In embodiments deploying a programmable computing system, it will be appreciated that both hardware and software architectures may be considered. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set forth hardware (e.g., machine) and software architectures that may be deployed in various example embodiments.

Thus, methods and systems for adapting e-books for more efficient transmission, storage and consumption have been described. Although the present subject matter has been described with reference to specific example embodiments, it will be evident that various modifications and changes may be made to these embodiments without departing from the broader scope of the subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” and so forth are used merely as labels and are not intended to impose numerical requirements on their objects.

The Abstract of the Disclosure is provided to comply with 37 C.F.R. §1.72(b), requiring an abstract that will allow the reader to quickly ascertain the nature of the technical disclosure. The Abstract is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

### Hardware Mechanisms

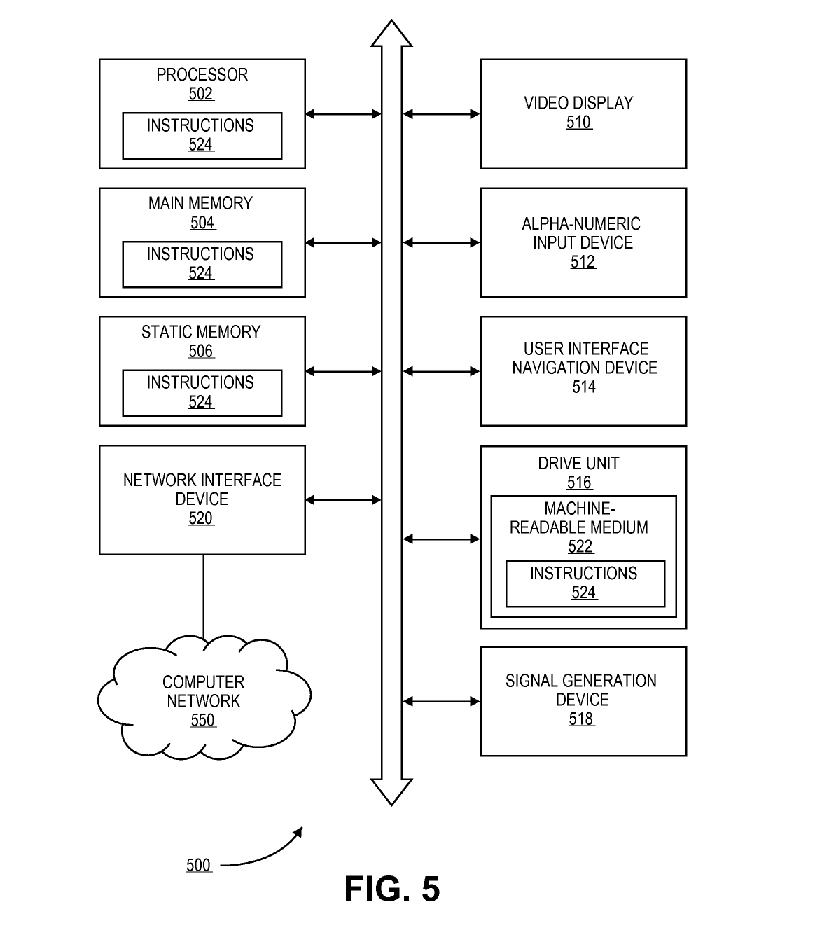

In an embodiment, elements of the techniques described herein may be implemented on, include, or correspond to a computer system. FIG. 5 is a block diagram of a machine in the example form of a computer system 500 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU), or both), a main memory 504, and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a user interface (UI) navigation device 514 (e.g., a mouse), a disk drive unit 516, a signal generation device 518 (e.g., a speaker), and a network interface device 520.

The disk drive unit 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504 and/or within the processor 502 during execution thereof by the computer system 500, the main memory 504 and the processor 502 also constituting machine-readable media.

While the machine-readable medium 522 is shown in an example embodiment to be a single medium, the term “machine-readable medium” may include a single medium or multiple media (e.g., a centralized or distributed database, and/or associated caches and servers) that store the one or more instructions 524 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

The instructions 524 may further be transmitted or received over a computer network 550 using a transmission medium. The instructions 524 may be transmitted using the network interface device 520 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

In the foregoing specification, example embodiments have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for adapting e-books, comprising:
analyzing a collection of resources comprising an electronic book, wherein the electronic book comprises a first and second page of a plurality of pages;
based on the analysis, creating a list describing the electronic book, wherein the list identifies the resources used in rendering the first and second page;
calculating the file size of each resource used in rendering the first page;
determining a maximum payload for the first page;
based on the determination, modifying the first page by moving resources used in rendering the first page to the second page, such that the payload of the first page does not exceed the maximum payload for the first page.

2. The method of claim 1, wherein the list comprises a hierarchical mapping of each page and its associated files.

3. The method of claim 1, further comprising:
calculating the file size of each file used in rendering the second page;
determining a maximum payload for the second page;
based on the determination, modifying the second page by moving files used in rendering the second page to a subsequent page of the plurality of pages, such that the payload of the second page does not exceed the maximum payload for the second page, wherein the maximum payload for the second page is not equal to the maximum payload for the first page.

4. The method of claim 1, further comprising:
adding to the list a set of rules, wherein the rules specify whether a particular resource is to appear alone on a page or appear together with other resources on a page, as well as specifying the relative positioning of the particular resource.

5. The method of claim 1, wherein the maximum payload for the first page of the plurality of pages is determined based on the location of the first page in the plurality of pages.

6. The method of claim 1, wherein the maximum payload for the first page of the plurality of pages is determined based on data describing parameters of potential electronic book reading environments.

7. One or more computer-readable storage mediums storing one or more sequences of instructions for adapting e-books, which when executed by one or more processors, causes:
analyzing a collection of resources comprising an electronic book, wherein the electronic book comprises a first and second page of a plurality of pages;
based on the analysis, creating a list describing the electronic book, wherein the list identifies the resources used in rendering the first and second page;
calculating the file size of each resource used in rendering the first page;
determining a maximum payload for the first page;
based on the determination, modifying the first page by moving resources used in rendering the first page to the second page, such that the payload of the first page does not exceed the maximum payload for the first page.

8. The one or more computer-readable storage mediums of claim 7, wherein the list comprises a hierarchical mapping of each page and its associated files.

9. The one or more computer-readable storage mediums of claim 7, further comprising instructions, which when executed by one or more processors, cause:
calculating the file size of each file used in rendering the second page;
determining a maximum payload for the second page;
based on the determination, modifying the second page by moving files used in rendering the second page to a subsequent page of the plurality of pages, such that the payload of the second page does not exceed the maximum payload for the second page, wherein the maximum payload for the second page is not equal to the maximum payload for the first page.

10. The one or more computer-readable storage mediums of claim 7, further comprising instructions, which when executed by one or more processors, cause:
adding to the list a set of rules, wherein the rules specify whether a particular resource is to appear alone on a page or appear together with other resources on a page, as well as specifying the relative positioning of the particular resource

11. The one or more computer-readable storage mediums of claim 7, wherein the maximum payload for the first page of the plurality of pages is determined based on the location of the first page in the plurality of pages.

12. The one or more computer-readable storage mediums of claim 7, wherein the maximum payload for the first page of the plurality of pages is determined based on data describing parameters of potential electronic book reading environments.

13. The one or more computer-readable storage mediums of claim 7,

14. The one or more computer-readable storage mediums of claim 7,

15. A method for adapting e-books, comprising:
analyzing a collection of resources comprising an electronic book, wherein the electronic book comprises a plurality of pages;
creating an electronic manifest, wherein the electronic manifest associates each of the plurality of pages with the particular resources comprising each of the plurality of pages;
storing in the manifest data defining a maximum payload for each page of the plurality of pages;
causing the manifest to be downloaded to an electronic book reader device;
based on the manifest, generating at the electronic book reader device a virtual layout of the plurality of pages, wherein the layout specifies which resources are to appear on which page based on the maximum payload defined for each page;
causing a first page of the plurality of pages to be displayed on the electronic book reader device, wherein the step of displaying the first page comprises downloading the resources associated with the first page;
causing resources associated with a second page and a third page of the plurality of pages to be downloaded to the electronic book reader device, wherein the second page and the third page are adjacent to the first page.

16. The method of claim 15, further comprising storing data indicating whether a particular resource of the collection of resources has been downloaded to the electronic book reader device.
